(19) United States
(12) Patent Application Publication
(10) Pub. No.: US 2021/0382476 A1
(43) Pub. Date: Dec. 9, 2021

(54) AUTONOMOUS LAWN MOWING SYSTEM

(71) Applicant: Scythe Robotics, Inc., Longmont, CO (US)

(72) Inventors: John Gordon Morrison, Longmont, CO (US); Isaac Heath Roberts, Longmont, CO (US); Kevin Peter McGlade, Denver, CO (US); Davis Thorp Foster, Boulder, CO (US)

(21) Appl. No.: 16/894,379

(22) Filed: Jun. 5, 2020

(51) Int. Cl. G05D 1/00; G05D 1/02; A01D 34/00; G06Q 10/00; G06Q 10/04; G06Q 10/06; G06Q 30/00; G05B 19/048; G01S 17/931; G01S 13/931; G01S 15/931

(52) U.S. Cl. CPC G05D 1/0027; A01D 2101/00; G05D 1/005; G05D 1/0219; G05D 1/0238; G05D 1/0246; G05D 1/0255; G05D 1/0257; G05D 1/0278; G05D 1/0297; A01D 34/008; G06Q 10/20; G06Q 10/047; G06Q 10/06315; G06Q 30/016; G05B 19/048; G01S 17/931; G01S 13/931; G01S 15/931; G05D 1/0088; G05D 2201/0208; G05D 1/0038

(57) ABSTRACT

An autonomous lawn mowing system and method comprising receiving data from at least one autonomous lawn mower of a fleet of autonomous lawn mowers. The data comprising at least sensor data from one or more sensors associated with the at least one autonomous lawn mower. The sensor data is captured while the at least one autonomous lawn mower traversed an environment in accordance with a mow pattern. Based at least in part on the data, generating information indicative of one or more of: a diagnostic of the at least one autonomous lawn mower, an attribute associated with the environment, or a metric associated with the at least one autonomous lawn mower performing a task, and providing the information to a user.

### BACKGROUND

In a typical commercial lawn mowing operation, one or more mowers are transported to a location to be mowed. Each mower is operated by an operator that rides on a mower. There are no diagnostics performed on the mower, the grass, the environment in which the mowing occurs, or any other aspect of the mowing process. If the mower breaks down, the driver or site manager calls for repairs. If the grass is in need of attention—watering, fertilizer, weed killer—the mower driver or site manager will contact office staff who then contacts the customer and/or various service providers to perform an analysis of the grass and take appropriate remedial action.

### BRIEF DESCRIPTION OF THE DRAWINGS

The invention will now be described, by way of example, with reference to the accompanying drawings, where like numerals denote like elements, a leftmost numeral indicates the original figure in which the element is found, and in which:

FIG. 1 is a schematic view of an autonomous lawn mowing system in accordance with an example of the invention;

FIG. 2 is a block diagram of an autonomous lawn mowing system in accordance with an example of the invention;

FIG. 3 is a flow diagram of an example of operation of a mower within the system of FIG. 1 to mow a lawn and collect data related to the mower and the job site being mowed for processing within the system of FIG. 1;

FIG. 4 is a flow diagram of an example of operation of the server within the system of FIG. 1;

FIG. 5 is a flow diagram of an example of a mower diagnostics method performed by the server within the system of FIG. 1;

FIG. 6 is a flow diagram of an example of a data analysis method performed by the server within the system of FIG. 1;

FIG. 7 is a flow diagram of an example of a mowing pattern generation and optimization method performed by the server within the system of FIG. 1;

FIG. 8 is a flow diagram for generating user information based at least in part on sensor data received during operation of the system depicted in FIG. 1;

FIG. 9 is a flow diagram of an example for determining and notifying a user of environmental requirements using the system of FIG. 1; and

FIG. 10 is a flow diagram of an example of a fleet management method performed by the server within the system of FIG. 1.

### DETAILED DESCRIPTION

The following detailed description describes techniques (e.g., methods, processes, and systems) capable of autonomously mowing grass and providing data analytics regarding the environment in which the mower operates, the mower, and the landscape business that operates the mower. In those examples described in detail herein in which a fleet of autonomous mowers is used for mowing, data analytics may be determined over the entirety of the fleet for fleet management, customer support, and business development.

A commercial landscaping business may use examples of the present invention to holistically improve their business through substantial data collection regarding their job sites and the tasks performed at those job sites coupled with optimization of the use of their mower fleet and personnel supporting the fleet. The autonomous lawn mowing system not only reduces personnel requirements through the use of autonomous mowers but uses data analytics to optimize business and operation efficiencies across the landscaping business.

Generally speaking, a mower fleet comprises a plurality of individual mowers, which may be combinations of autonomous, semi-autonomous, and/or manually controlled mowers. Depending on the size of the job, one or more mowers are allocated to a given site. On a given job site, the mowing may be performed using a mix of some autonomous mowers, some semi-autonomous mowers (e.g., those mowers which may have some capabilities which are autonomous and/or which are capable of operating autonomously for at least a portion of the time) and some mowers being driven by humans (i.e., manual mowers). Each autonomous or semi-autonomous mower has a suite of sensors to primarily facilitate autonomous or semi-autonomous mowing. However, the data collected by these sensors may also be used to understand the environment surrounding each mower and improve the overall business of the landscape business operator. Such sensors may comprise, for example, one or more of cameras, radar, pose (position and/or orientation) systems, diagnostic sensors, accelerometers, torque sensors, wheel rotation sensors (e.g., rotary encoders) or the like. This suite of sensors provides a view of the environment in which the autonomous mower is operating. Knowing the environment in which the mower operates facilitates data analytics to provide mower diagnostics, enhance mowing patterns, improve customer interaction, optimize fleet management, and the like.

The techniques may provide a technical solution to a technical problem of determining a situational environment in which an autonomous mower system is operating or has operated to optimize the behavior of a mower fleet and provide fleet related operational information to users. The techniques described herein may improve the functioning of a computer through function optimization, improved processing efficiencies, improved and optimized autonomous behavior of mower(s), etc. Understanding the environment in which the mower(s) operate facilitates improvement in the system's server functionality by providing substantial amounts of data for the server to process and use to determine effective solutions for users as described in detail below. Further, though described in the context of an autonomous lawn mower (and/or fleet thereof), the invention is not meant to be so limiting and are provided for illustrative purposes only. It would be appreciated that the techniques described herein would be equally applicable to any other service robotics platform and/or fleets thereof such as, but not limited to, other agricultural tasks—harvesting, planting, etc., naval tasks (whether submarine, surface vessel or otherwise), and the like.

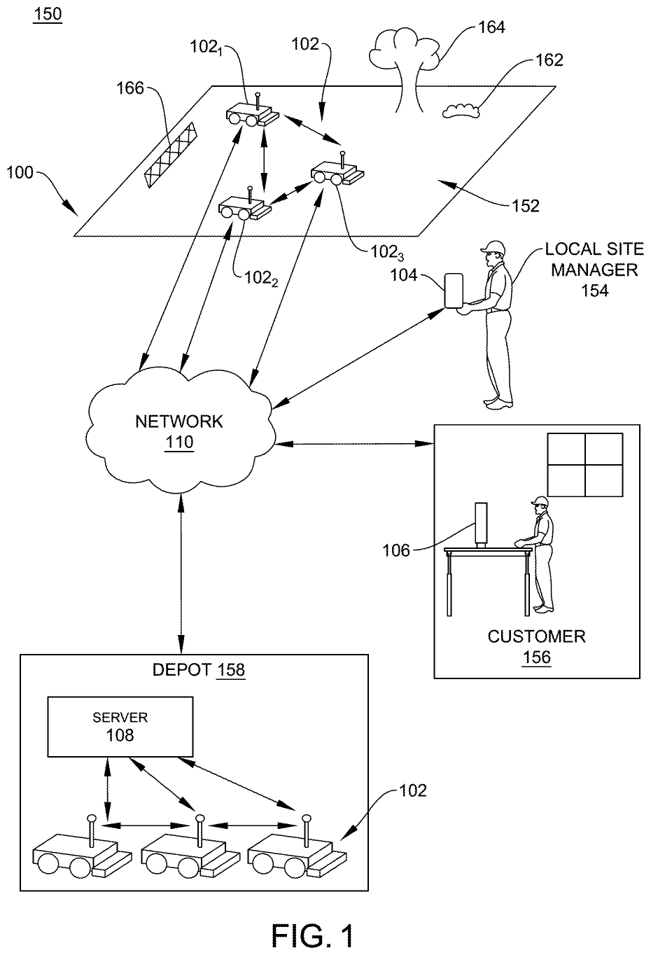

FIG. 1 is a schematic view of an autonomous lawn mowing system 100 being used within the context of a landscaping business 150 in accordance with an example of the invention. In the depicted example, the lawn mowing business 150 comprises a job site 152, at least one local site manager 154, at least one customer 156, and at least one depot 158. The business 150 may comprise a number of employees to assist at the job site 152 as well as at the depot 158. The job site 152 comprises a lawn 160 which contains elements of the lawn's environment such as, for example, bushes 162, trees 164, fences 166 and the like. These elements generally form obstacles to the mowing operation.

At a given job site, such as job site 152, at least one local site manager 154 oversees operation of employees working at the job site 152 as well as manages the mowing operation, as described in detail below. The local site manager 154 may be a landscape business representative and/or a customer representative that may or may not physically be present at the job site 152. The at least one customer 156 may be the owner or manager of the property upon which the lawn 152 resides. In general, the customer 156 has an interest in the lawn mowing operation and generally is a person that makes decisions regarding landscaping services to be applied to the job site, e.g., mowing, trimming, weeding, fertilizing, and the like. For example, the customer 156 related to a housing complex may be a manager of a home owners association (HOA) or a board member of the home owner's association. For a commercial property, the customer 156 may be a property owner or manager. Both the site manager 154 and customer 156 benefit from reporting of information regarding the autonomous lawn mowing system 100 as described below in accordance with examples of the present invention.

The autonomous lawn mowing system 100 comprises one or more mowers 102₁, 102₂, 102₃, . . . 102ₙ (whether autonomous, semi-autonomous, or manually controlled and collectively referred to as a mower fleet or portion of a fleet, and referenced as fleet 102), local site manager device 104, and a server 108. A computer network 110, e.g., the Internet or cloud, communicatively couples the mowers in the fleet 102, the local site manager device 104, and the server 108. The landscaping business 150 may have multiple depots 158 housing portions of the mower fleet 102. In FIG. 1, the server 108 is depicted as being housed in a depot 158. In other examples, the server 108 may be housed elsewhere in, for example, a data center either as a standalone server for the landscaping business 150, as part of the Internet cloud, or otherwise accessible by the fleet 102, local site manager device 104, and/or one or more customer devices 106. As shall be described below, the server 108 provides data analytics regarding data collected by the one or more autonomous mowers 102 in addition to fleet-level control, scheduling, user notifications, etc.

In one example, the local site manager device 104 executes application software on a smart phone, other smart device, or web-based application to facilitate staff at the job site 152 having access to data and/or be sent messages regarding the job site 152 and the tasks being performed at the job site. As a non-limiting example, a local site manager 154 may use such an application or access a website to provide the local site manager detailed information regarding all aspects of the job site as well as the ability to control one or more mowers. More specifically, the local site manager device 104 may be used to perform one or more of the following tasks: assist in mower deployment preparation and sensor calibration, initiate data synchronization amongst mowers and the server, facilitating mower(s) at a particular job site joining the system 100, receive job reports (or other user information) from mowers and the server, receive productivity reports, facilitate uploading and/or configuring mow patterns to the mowers, receive job progress and completion reports, facilitate perimeter control of mowers, provide driver assistance to move mowers from one job site to another (i.e., chaperone mower movement), provide driver assistance to assist mowers stopped because of obstacles, and the like. The local site manager device 104 may further provide real-time feedback of each mower's health and well-being including, but not limited to, battery charge, battery life, mower runtime total, mower runtime for the current job, help requests (e.g., mower stuck, stopped or broken), or the like.

Via the network 110, one or more customer devices 106 (e.g., computer, smart phone, personal digital assistant, and the like) executing software or accessing a website to access information stored on the server 108 and be sent information regarding their job site 152, as will be discussed in detail herein. In one example, the customer device 106 accesses the server 108 via the network 110 to view/download information. In another example, the customer 104 may automatically be sent information from the server 108, local site manager 104 and/or the mowers 102. The local site manager 104 may do the same—view/download information or be sent information automatically. The customer device 106 and site manager device 104 may have such access (or otherwise receive) information and/or data through a website, computer application or mobile application.

The mowers 102 at a given j ob site 152 may communicate amongst themselves whether via a local WiFi network created amongst the mowers 102 (e.g., a mesh network) or via the network 110. In this manner, the mowers 102 may share data, in real-time, at the job site 152 to facilitate learning the environment in which the mowers operate. In addition, the mowers 102 may communicate amongst each other and with the server 108 while located in the depot 158. As such, at the depot 158, the mowers 102 may share data amongst themselves as well as upload data to the server 108. The server 108 may also download software updates and instructions to the mowers 102 while they are located in the depot 158. Communication in the depot may occur via wire, wireless (e.g., WiFi) or the network 110.

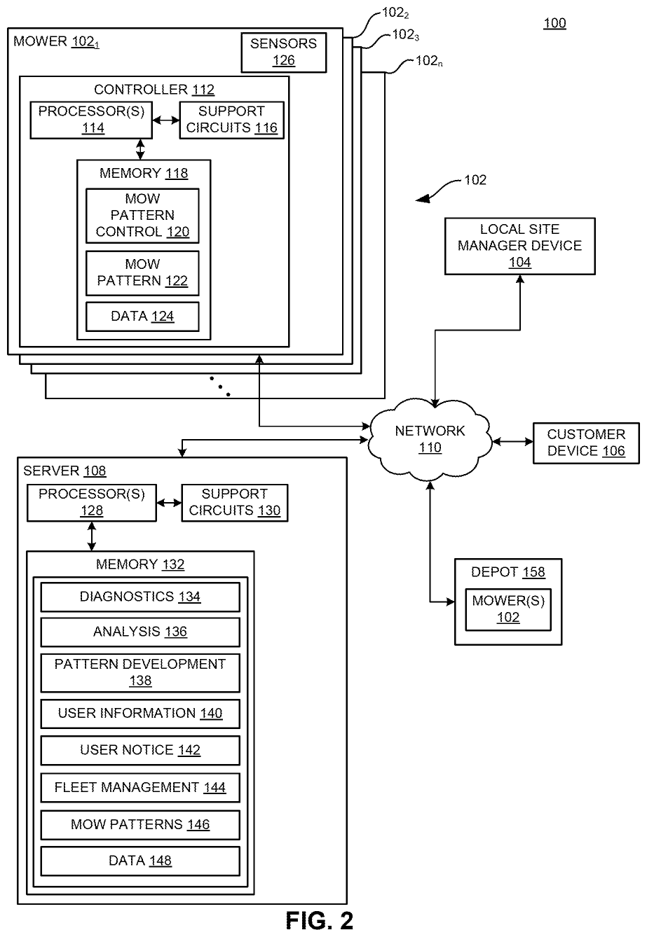

FIG. 2 depicts a block diagram of the autonomous mowing system 100 in accordance with one example of the invention. The system 100 comprises one or more autonomous mowers 102₁, 102₂, 102₃, . . . 102ₙ (collectively referred to as a mower fleet or portion of a fleet, and referenced as fleet 102), the local site manager device 104, and the server 108. A computer network 110, e.g., the Internet, communicatively couples the mowers in the fleet 102, the local site manager device 104, the depot 158 and the server 108.

For command and control purposes, each mower 102₁, 102₂, 102₃, . . . 102ₙ comprises a suite of sensors 126 and one or more controller(s) 112. Each mower, of course, comprises components such as a mowing deck housing blades, a motor or motors for driving the wheels and blades, steering mechanism, and the like. In one embodiment, the mower is powered by electricity (e.g., a battery) and the blade and wheel motors are electric motors. The sensors 126 may comprise one or more of cameras (whether RGB, monochrome, infrared, ultraviolet, etc. whether wide field of view, narrow field of view, or the like), radar(s), lidar(s), time of flight sensors, accelerometer(s), torque sensor(s), magnetometer(s), location system(s) (e.g., a Global Navigation Satellite System (GNSS) receiver), battery management systems, wheel encoder(s), motor sensor(s), orientation sensor(s), ultrasonic transducers, inertial measurement units (IMUs) (which may comprise accelerometers, gyroscopes, and/or magnetometers), and/or the like. The sensors provide information (sensor data) regarding the mower functionality and the environment surrounding the mower. Sensor data from such sensors 126 may be used by the one or more processor(s) 114 (or otherwise transmitted to a device remote from the autonomous lawn mower 102) to determine one or more of mower position/orientation (pose), determine torque/energy usage, perform obstacle avoidance, and/or determine information regarding the job site such as, but not limited to, determining if tree limbs require removal, determining when tree and shrub pruning is needed, determining the condition of the grass, determining when leaves require removal or the like. Additional sensors may be used to determine the condition of the grass. Such sensors are described in detail in commonly assigned, U.S. patent application Ser. No. 16/254,650 entitled “Moisture and Vegetative Health Mapping” and filed on Jan. 23, 2019, the entire contents of which are hereby incorporated by reference.

The controller 112 comprises at least one processor(s) 114, support circuits 116, and memory 118. The controller 112 may include one or more processors as part of the processor(s) 114, any of which, either individually or in combination, are capable of performing the operations described herein. Some processing to fulfill the functions of the mower may be performed locally, may be performed remotely on server 108 (or other system/subsystem including, but not limited to, the local site manager device 104 and/or the customer device 106), or may be shared and performed locally and remotely. For example, the processor(s) 114 may comprise, one or more or any combination of, microprocessors, microcontrollers, central processing units (CPUs), graphics processing units (GPUs), digital signal processors (DSPs), field programmable gate arrays (FPGAs), application specific integrated circuits (ASICs), or the like.

The support circuits 116 comprise circuits and devices that support the functionality of the processor(s) 114. The support circuits 116 may comprise, one or more or any combination of clock circuits, communications circuits, cache memory, power supplies, interface circuits for the various sensors 126, and the like.

Memory 118 is an example of non-transitory computer readable media capable of storing instructions which, when executed by any of the one or more processor(s) 114, cause the controller 112 to perform any one or more of the mower operations described herein. The memory 118 can store an operating system and one or more software applications, instructions, programs, and/or data to implement the methods described herein and the functions attributed to the various systems. In various implementations, the memory 118 can be implemented using any suitable memory technology, such as static random-access memory (SRAM), synchronous dynamic RAM (SDRAM), nonvolatile/Flash-type memory, or any other type of memory capable of storing information. The architectures, systems, and individual elements described herein can include many other logical, programmatic, and physical components, of which those shown in the accompanying figures are merely examples that are related to the discussion herein. Additionally, or alternatively, the memory 118 is capable of storing raw sensor data from the one or more sensor(s) 126, compressed or downsampled sensor data, output of one or more machine learning models (e.g., feature maps of neural networks), and/or representations of the raw sensor data.

The memory 118 may store various programs and data such as, for example, but not limited to, a mow pattern control program 120 that uses a mow pattern 122. Sensor data may be locally stored as data 124. The data 124 (or representations/derivations therefrom) may be, in some examples, communicated to the local site manager device 104, customer device 106 and/or server 108, as needed or requested. One or more communication circuits within the support circuits 116 are used for communicating data 124 as well as receiving mow patterns 122 and/or updating the mow pattern control software 120. The mowers 102 may communicate directly amongst and between themselves and/or via the server 108.

Such communications circuits may use protocols that include, but are not limited to, WiFi (802.11), Bluetooth, Zigbee, Universal Serial Bus (USB), Ethernet, TCP/IP, serial communication, and the like. In at least some examples, to minimize an amount of data transferred (as raw sensor data may amount to upwards of multiple gigabytes to multiple terabytes per day), raw sensor data from the one or more sensors 126 may be downsampled or compressed before transmission. In at least one example, sensor data (whether raw, compressed, downsampled, a representation thereof, or otherwise) may be automatically uploaded to another computing device when in a particular location (e.g. when at the landscaper's depot, or other preselected user location). In such examples, the controller 112 may determined, e.g., based at least in part on sensor data from the one or more sensors 126 that the mower 102 is in a depot and begin processing and/or communication of the sensor data. In at least some examples, processing and/or communication may be based on whether the mower 102 is currently connected to a power supply for charging. Representations of data may include, for example, averages of the data, feature maps as output from one or more neural networks, extracted features of the data, bounding boxes, segmented data, analytics as described herein and the like.

In one example, the site manager device 104 uploads one or more mow patterns 122 into memory 118. The mow patterns 122 may also be uploaded at the depot from the server 108 and/or determined based at least in part on the mow pattern control software 120. A specific mow pattern 122 is selected and/or determined for the site to be mowed. The mow pattern control software 120 is executed to use the selected mow pattern 122 to control the mower in a particular pattern as the lawn is mowed. Generally, a given mower mows in a pattern formed of stripes with a turn at the end of each stripe. The pattern may define where obstacles are located and instruct the mower to avoid each obstacle, the mower may autonomously discover and avoid the obstacles, or the mower may stop when encountering an obstacle and await human intervention.

As the mower moves, the sensors 126 create sensor data 124 regarding the mower functionality and its surrounding environment. The data 124 may be streamed as it is collected through the network 110 to the server 108, or the data 124 may be stored in memory 124 to be downloaded to the server 108 at a later time, or some data may be stored locally and some data may be streamed to the server 108. Certain data or messages regarding the data may be sent directly to the local site manager device 104 such as error messages, messages regarding obstacles that block the mower's path, and the like, though any data collected or determined is contemplated as being available to the site manager device 104 or the customer device 106.

In one example, the server 108 uses the data 124 communicated from the mower fleet 102 to provide analytics to assist landscape company management. The server 108 comprises at least one processor 128, support circuits 130, and memory 132. The server 108 may include one or more processors as part of processor 128, any of which capable of performing one or more of the operations described herein. Some processing to fulfill the functions of the mower may be performed locally on the server 108, may be performed remotely on mower(s) 102, or may be shared and performed locally and remotely. Furthermore, the local site manager device(s) 104 and/or customer device(s) 106 may be provided data from the mowers 102 and/or the server 108 and locally perform some of the data processing described herein. To facilitate such data processing, the at least one processor 128 may comprise one or more microprocessors, microcontrollers, central processing units (CPUs), graphics processing units (GPUs), digital signal processors (DSPs), field programmable gate arrays (FPGAs), application specific integrated circuits (ASICs), or the like. Such processors may be the same as those described with respect to processor(s) 114 above.

The support circuits 130 may comprise circuits and devices that support the functionality of the processor(s) 128. The support circuits 130 may comprise, but are not limited to, clock circuits, communications circuits, cache memory, power supplies, and the like. Such support circuits 130 may be the same as those described with respect to support circuits 116 above. Memory 132 may comprise non-transitory computer readable media similar to those described above with respect to memory 118.

The memory 132 may store various programs, sub-programs, sub-routines and data such as, for example, but not limited to, analytic software 150, which comprises one or more sub-programs. In one example, the sub-programs include, for example, but not limited to, at least one of diagnostic software 134, analysis software 136, pattern development software 138, user information generation software 140, user notification software 142, and/or fleet management software 144. Sensor data from the mower(s) 102 may be locally stored as data 148. The data 148 may also be communicated to the local site manager device 104, customer device 106 and/or the mowers 102. The server 108, when executing the pattern development software 138 generates and stores mow patterns 146. Of course, though depicted in FIG. 1 as being performed on the server 108 for illustrative purposes, the disclosure is not meant to be so limiting. Indeed, the pattern development software 138 may reside on the mowers 102. In those examples in which the pattern development software 138 resides on the mowers 102, the mow pattern may be determined based at least in part on map data available to the mower 102, a desired area to mow, and one or more of a current position and/or orientation of the mower 102 relative to the map. One or more communication circuits within the support circuits 130 is used for communicating data 148 as well as receiving data 124 and/or updating the mow patterns 122 on the mowers 102.

Such communications circuits may be the same as those described with respect to support circuits 116 above.

As shall be described in more detail below, the system 100 provides a landscaping company's management a holistic view of the mower fleet and the mowing job sites. The system 100 aggregates job site data from the mower fleet and across job sites to facilitate mower environment mapping, provide an extensive level of autonomous mower behavior, and provide customers with information about their job sites. The data provided by each mower in the fleet is analyzed to optimize the business as a whole, enabling management to provide more services, reduce costs and efficiently use the autonomous mowers.

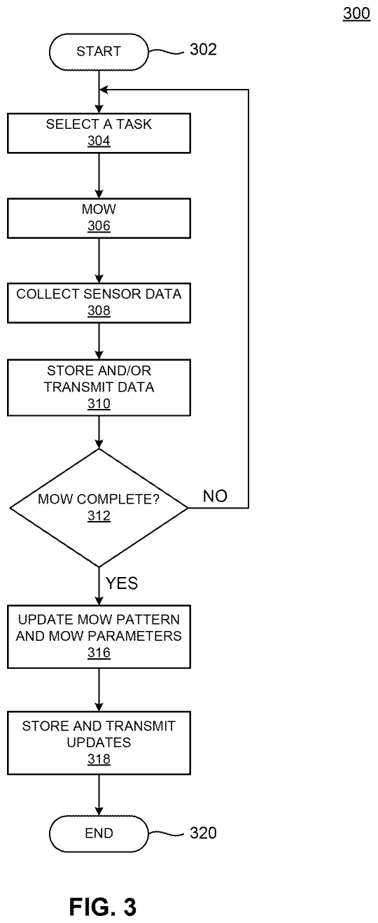

FIG. 3 depicts a flow diagram of a method 300 for operation of a mower when executing the mow pattern control software (e.g., 120 in FIG. 1) in accordance with an example of the present invention. When a mower first arrives on a site, the local site manager, or other employee, positions the mower at a start location for the particular job site. If multiple mowers are mowing the site, all the mowers are positioned at their start locations, though not necessarily contemporaneously. Once the mower(s) are positioned, the site manager assigns a task to each mower—a task comprises a mow pattern and associated mow parameters. Once a first mower is positioned, the site manager initiates the mow pattern control software represented by method 300. The method 300 starts at 302 and proceeds to 304. At 304, the method 300 selects a task to be performed. The selection of a task may be facilitated through control from the server or may be selected locally by the local site manager. The mow parameters, for example, control mowing attributes such as blade height, mowing speed, and mower turning dynamics (e.g., pattern used for turning as, for example, K-turn, U-turn, and the like). At 304, the mower sensors may be initialized.

At 306, mowing commences according to the pattern as may be determined, for example, by the mow control software 120. Such a pattern may comprise, for example, a series of waypoints indicative of positions for the mower to traverse over a region, and/or any one or more control signals to control the mower and/or states of the mower associated with the one or more way points such as, but not limited to, torques, speeds, blade speeds, blade heights, etc. In at least some examples, such waypoints may be determined based on the number of additional mowers in the fleet, if any (e.g., whether configured to mow in a v-pattern, alternating stripes, contained regions, or the like). As the mower proceeds, at 308, sensor data from the one or more sensors is collected.

In some instances, a region of the job site or the entire job site may require multiple passes (i.e., a multi-cut) of the mower to ensure the grass is cut to a proper length. Double cutting may be required when grass is wet or overgrown as well as to clean up mower side discharge to improve grass mulching. The decision to multi-cut may be made by the mower when its sensors detect that the grass is not at the proper height after the first cutting pass or that discharged grass has not been properly mulched. Alternatively, a human, such as the local site manager or customer, may intervene and cause the mower to perform one or more additional cutting passes over a region.

At 310, the method 300 stores and/or transmits the sensor data. Sensor data may be stored locally, transmitted to the server, and/or have some data locally stored and some data sent to the server. Some data may be used locally by the mower and stored locally, while other data may only be useful to the server and will be transmitted thereto. In other examples, all the data may be stored locally and coupled to the server when the mower is returned to the depot. In some instances, data may be made available to a customer and/or local site manager. For example, a customer may be sent a message informing them that mowing has commenced or has been completed. In another example, the local site manager may be informed when an error has occurred, or an obstacle has been encountered that causes mowing to cease. Of course, the invention is not meant to be so limiting and data from the mower (e.g., sensor data, control data, error data, message data, and/or data derived therefrom) may be sent to any one or more remote system.

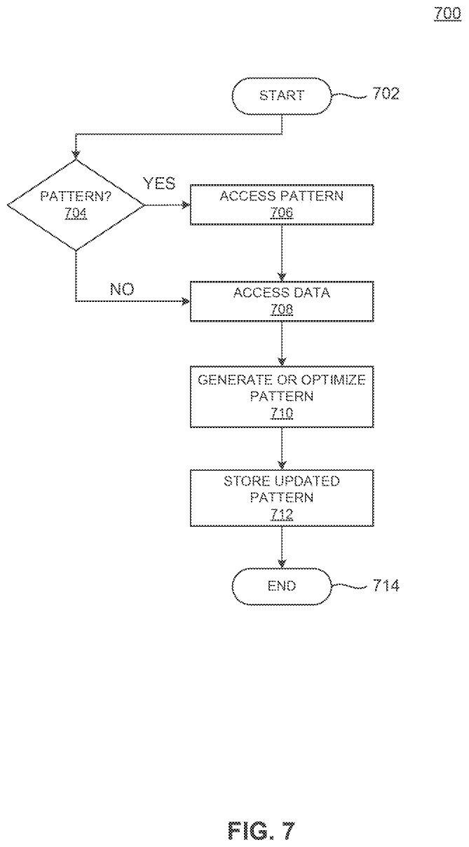

At 312, the method 300 determines whether the mowing is complete. In at least some examples, operation 312 may be performed by the mow control software (e.g., 120) determining whether the pattern defined in the mow pattern has been fully traversed, or if there is additional portions of the pattern to be completed. If the query is negatively answered (e.g., where there is additional waypoints of a pattern that have not been visited), mowing continues and method 300 returns to 306. If, however, the operation 312 is affirmatively answered, the method 300 proceeds to 316. At 316, the collected data is processed to update the mow pattern and the associated mow parameters. Data processing for mow pattern updates may occur at the server (e.g., 108) or at the mower itself. For example, the data may contain fixed obstacles that require avoiding that were not contained in the original mow pattern. In such an instance, the mow parameters and/or associated map of the region may be updated. In such an example, the mow parameters may be associated with the map of the region to later be used, for example, in similar environmental conditions, similar patterns, or the like. The update may require confirmation from the server, be performed at the server and later made available to the mower, or may occur locally. In addition, as described below with respect to FIG. 7, the server may analyze data from an individual mower or all the data from the mower fleet at the job site and produce an update of the map of the region, mow pattern and/or mow parameters to optimize mowing performance.

At 318, the mow pattern updates computed at the mower are stored and/or transmitted to the server. These updates may also be communicated on a peer-to-peer basis between the mowers with or without server interaction. As shall be described below, the server uses the sensor data to improve mowing and overall management of the fleet. At 320, the method 300 ends.

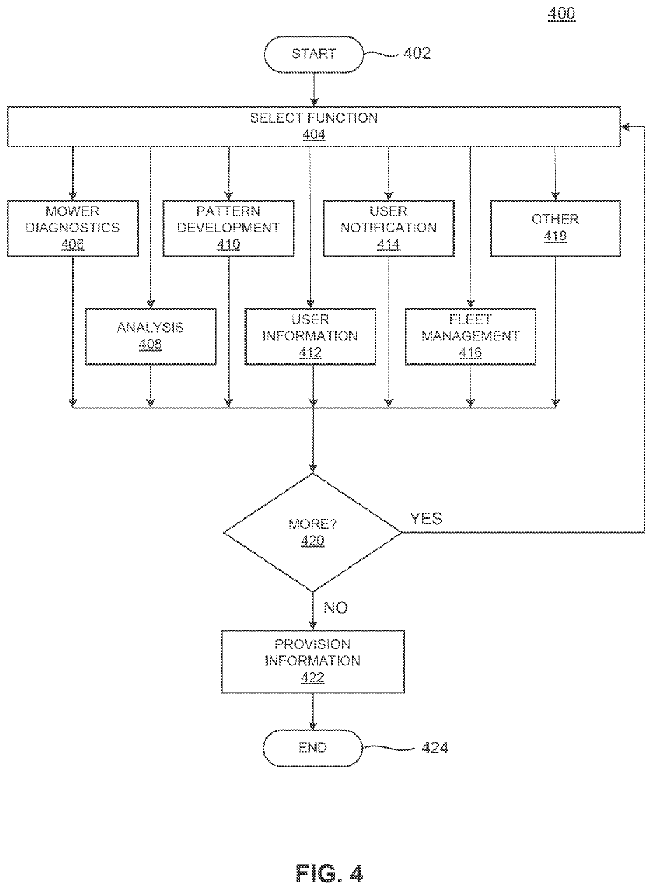

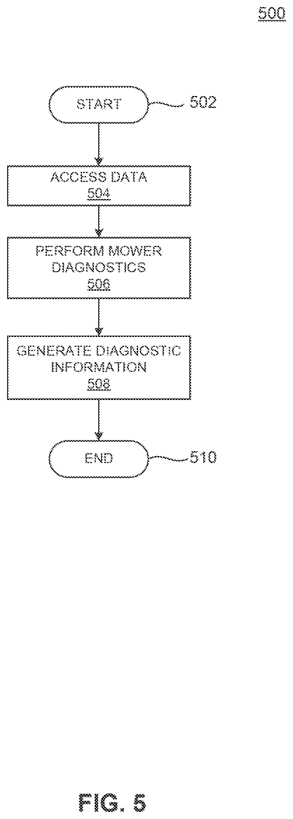

FIG. 4 depicts a flow diagram of a method 400 performed by the server 108 when executing the analytics software 150 of FIG. 1 in accordance with an example of the invention. The method 400 begins at 402 and proceeds to 404 where a user may select a specific function to be performed. Alternatively, the method 400 may automatically select a function or functions to be performed. The functions may include, for example, but are not limited to, at least one of mower diagnostics, data analysis to determine environment attributes of the environment surrounding the mower(s), mow pattern development, user information generation, user notification generation, fleet management, and/or other functions that are useful for landscape business optimization and management. In the example of FIG. 4, each function is represented by a sub-program. The sub-programs comprise, for example, at least one of: mower diagnostics sub-program 406, data analysis sub-program 408, mow pattern development sub-program 410, user information sub-program 412, user notification sub-program 414, fleet management sub-program 416, and/or other sub-programs 418 that are useful for landscape business optimization and management. In the depicted example the sub-programs are launched upon selection by a user. In other examples, the sub-programs may be automatically launched and/or called from another sub-program or program. Each sub-program is described in detail with respect to FIGS. 5 through 10 below.

After a selected sub-program is performed at 412 through 418, the method 400 queries at 420 whether an additional sub-program is to be executed. If the query is affirmatively answered, the method 400 returns to 404 to enable a user to select another sub-program to execute. If the query at 420 is negatively answered, the method 400 proceeds to 422 where the method 400 provisions information in response to the sub-program or sub-programs that have been executed. Provision is generally defined as providing, reporting, communicating, and/or displaying information to a user. Additional examples of provisioned information are described in detail below with respect to the one or more additional flow diagrams and their corresponding output. In one example, the information may be in the form of data that is communicated to one or mowers in the fleet. In another example, the information may be processed data or raw data communicated to a user, e.g., customer, local site manager, landscape business management and/or employees, etc. The method 400 terminates at 424.

FIG. 5 depicts a flow diagram of a method 500 that is performed upon execution of the mower diagnostics sub-program 406 of FIG. 4 in accordance with an example of the invention. The method 500 begins at 502 and proceeds to 504 where the method accesses (or otherwise receives) data that was previously provided by the mower while it was operating. Such data may comprise, for example, sensor data, control data, message data (e.g., data received from any one or more additional autonomous mowers in a fleet), error data, input data (e.g., from the local site manager and/or the customer), and/or data derived therefrom. In one example, the diagnostics method 500 may be performed in real-time while the mower is operating. In another example, the diagnostics may be performed when the mower returns to the depot and/or the data is uploaded to a remote location for additional processing.

At 506, the method 500 performs mower diagnostics on the mower data. The diagnostics review mower sensor information to, for example, ensure: the mower(s) are following instructions contained in the mow pattern; the mower(s) are closely tracking the specified mow pattern; battery power/state of charge and temperature are within norms; motor temperature is within norms; tire pressure from one or more pressure sensors associated with the wheels of the mower; a capacity of available memory on the mower is sufficient; software diagnostic information is within norms; hardware diagnostic information is within norms; functionality of the sensors (including cleanliness), or the like. The diagnostics also review operational functions such as: an amount of energy used by the mower (e.g., a difference in one or more of a state of charge or a voltage) required to mow the pattern; cutting efficiency; blade maintenance; requirement for and amount of human intervention to complete a task; a distance travelled by the autonomous lawn mower since a last maintenance service; or the like.

At operation 508, diagnostic information may be generated for a user and this information may be provided (e.g., reported, displayed, transmitted, etc.) to the user at 422 in FIG. 4. Diagnostic information may comprise identified errors and/or anomalies in the data to a user, as well as an overall health of the mower(s). In at least some examples, the diagnostic information may be compared to one or more thresholds. As non-limiting examples, a state of charge may be compared to a threshold state of charge, an amount of energy required to perform a task (e.g., mowing of a region) may be compared to a previous and/or threshold energy, a tire pressure may be compared to a threshold tire pressure, and the like. In such examples, if, upon comparison, the mower parameter (or combinations of mower parameters) does not (or do not) meet or exceed (or, in some cases, meets or exceeds) the threshold, further diagnostics may be performed or requested and/or replacement parts may be ordered. In one such example, if a battery state of health (e.g., battery capacity) is less than a threshold state of health, a replacement battery may be sent for replacement. In a similar example, if the energy (or time) required to mow a pattern or otherwise perform a task meets or exceeds a threshold (or is some threshold percentage above a previous energy or time), a flag may be sent to a developer and/or a version of the mowing control software may be reverted to a most recently used version. Of course, any other diagnostic or error may be made available, whether manually or autonomously based on the mower health data determined at 506 and generated as diagnostic information at 508.

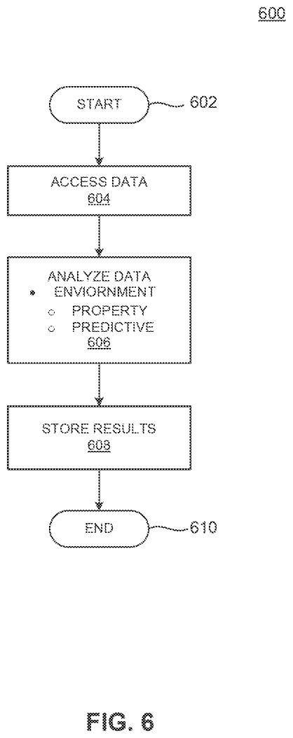

FIG. 6 depicts a flow diagram of a method 600 that is performed upon execution of the data analysis sub-program 408 of FIG. 4 in accordance with an example of the invention. The method 600 starts at 602 and proceeds to 604 where data from the mower(s) is accessed (or otherwise received). At 606, the method 600 analyzes the data for various attributes of the environment in which the mower(s) operate. In addition, the analysis may produce predictive information as shall be described below.

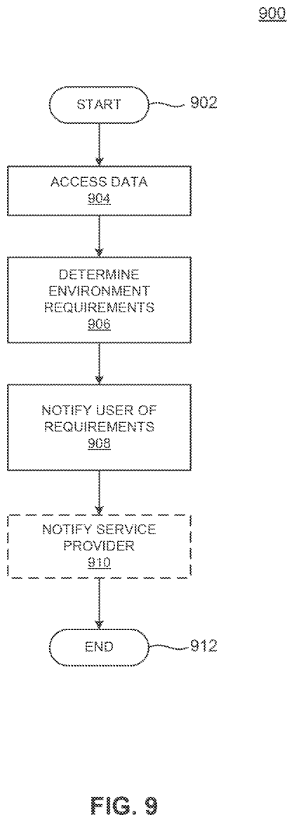

As for the environmental attributes, the method 600 reviews the sensor data, e.g., from the one or more cameras, radars, sonars, ultrasonics, lidar, IMUS, GNSS, rotary encoders, etc. to determine one or more of characteristics of: a lawn mowed by the mower, position and/or identity of obstacles in the environment, or position and/or identity of vegetation in the environment. For example, an analysis of the data may be used to identify vegetation within the environment being mowed, i.e., the identity of trees, bushes and types of grass surrounding the mower(s), as well as positions of the vegetation within the environment. In some such examples, the sensor data may be input into one or more machine learned models, such as convolutional neural networks, (or other computer vision techniques) to recognize foliage and/or obstacles encountered during mowing. A catalog of the types of trees, bushes and grass can be created for each job site based on, for example, the output of the machine learned model and associated with a map of the region mowed. In addition, from the sensor data, the health of the vegetation on the site may be assessed. In one example, this information is used to build an environmental model of the site such that the need for corrective measures can be assessed. If corrective measures, such as tree trimming, watering, chemical treatment and the like, are necessary, the method 600 uses the user notification sub-program (as described below with respect to FIG. 9) to notify the need for these services to a user, e.g., customer and/or site manager. Other environmental attributes that may be determined include the amount and characteristics of the grass being mowed at the site. The torque sensor information and blade deck height sensor information provide information regarding the height and thickness of the grass. Such vegetative health monitoring may be performed, for example, based on those techniques described in U.S. patent application Ser. No. 16/254,650 entitled “Moisture and Vegetative Health Mapping” and filed on Jan. 23, 2019, the entire contents of which are hereby incorporated by reference.

The environmental attributes further include property attributes, and at 606, the method 600 analyzes the sensor data, e.g., from the one or more cameras, radars, sonars, and/or lidar, to create a property map indicating the identity and/or position of obstacles such as barriers, buildings, fences or the like. As the mower traverses the property, mower pose (position and orientation) is used to map the property and determine locations of the property attributes. In some such examples, the sensor data may be input into one or more machine learned models, such as convolutional neural networks, (or other computer vision techniques) to recognize property attributes. Additionally, using similar identification and location techniques, the locations of holes, ruts, brown spots and the like in the lawn can be included in the property map. This information may be used by the mow pattern development sub-program 310 (as described below with respect to FIG. 7) to optimize the mow pattern for the property to avoid obstacles and damaged lawn areas.

Based at least in part on the environment attribute information, the system may perform a predictive analysis such that, at certain seasons of the year, tree trimming, leaf raking, flower planting, and the like can be pre-arranged for a customer. Thus, scheduling of services can be optimized across all customers of the landscape business.

The analyses described above may be performed across the mower fleet to develop maps of entire properties derived from sensor data supplied by a plurality of mowers performing tasks on various, different portions of a job site. Data may also be analyzed to optimize and automate transitions between properties where the transition is driven by a mower, e.g., moving from one lawn in a housing development to another lawn in the same development.

At 608, the method 600 stores the results of the analysis performed in 606 for use by other sub-programs or for provisioning information at 422 in FIG. 4. The method 600 terminates at 610.

FIG. 7 depicts a flow diagram of a method 700 that is performed upon execution of the mow pattern development sub-program 410 of FIG. 4 in accordance with an example of the invention. The method 700 updates existing mow patterns to improve mower behavior based at least in part on mower environment information and generates new mow patterns when none exist for a given job site.

During a mowing task, in one example, the mower moves along pre-defined plurality of waypoints that form a mow pattern. The waypoints may be associated with one or more desired states of the mower to be achieved successively including, but not limited to, given positions, orientations, velocities, mow heights, blade speeds, and the like. As the mower moves, data is collected regarding the environment surrounding the mower as well as, for example, the mower pose, velocity, acceleration, wheel rotation, and the like. This data is available to method 700 to facilitate optimizing the mow pattern that was previously used by the mower.

In addition, to produce a mow pattern for the first time, the system requires knowledge of the boundary of the region a mower is to mow. To gather boundary information, a mower is typically driven by a human along the perimeter of the region to be mowed, though such data may be provided in other means (such as via user-defined maps). As the mower is driven, the mower gathers data regarding the environment in which the mower operates as well as, for example, the mower pose, velocity, acceleration, wheel rotation, and the like. This data is available to method 700 to facilitate generating a mow pattern within the boundary as described below.

The method 700 begins at 702 and proceeds to 704 where the method 700 queries whether a current pattern for the job site exists. If the query is affirmatively answered, the method 700 proceeds to 706 where a current pattern is accessed (or otherwise received). If the query at 704 is negatively answered, the method 700 proceeds to 708 to access (or receive) sensor data that facilitates creation of a mow pattern, i.e., the system accesses the boundary information. If a pattern has been accessed at 706, the method 700 proceeds to 708 to access sensor data to be used to optimize the current mow pattern.

At 710, the method uses the data to either generate a new mow pattern or optimize an existing mow pattern. From the mowing boundary information, method 700 computes a mowing pattern for inside the boundary such that, when used by the mower, the mower mows the boundary and then follows a specified striping pattern to move the mower back and forth across the lawn from boundary edge to boundary edge while avoiding any known obstacles. Mowing parameters form part of the task to instruct the mower what form of turn to use at the end of each stripe as well as establish specific mow parameters including, for example, one or more of mowing speed, blade deck height, blade speed, and/or the like.

If a new pattern is being created, the method 700 uses the sensor data from the boundary drive and prepares a mow pattern using an optimization routine to optimize the number of stripes created by the mower within the boundary, a time to mow the region, an amount of energy consumed during mowing the region, or the like. Once the pattern is established the mow parameters (e.g., blade height, blade speed, whether mowing is engaged or not, mower speed, etc.) are set to nominal values (e.g., an average speed which may be based at least in part on a time of year, a variety of grass (e.g., St. Augustine, Ky. bluegrass, perennial ryegrass, etc.), etc.). After the mower is used with the newly created pattern, additional data is collected to enable the method 700 to update and optimize the mow pattern and parameters using the sensor data collected during the mowing process. In such an example, predicted values may be compared with recorded values from sensor values in performing the optimization. As a non-limiting example, a pattern may have been naively generated without knowledge of existing obstacles (trees, manmade structures, etc.) which exist inside the mapped boundary. Based at least in part on additional sensor data collected, a mowing pattern may be altered to accommodate for detected obstacles in order to optimize the mow. In any example, optimization may be with respect to one or more of time to mow, energy required to mow, number of stripes used, distance travelled, and the like.

If a mow pattern exists, the method 700 analyzes the sensor data to improve the mow pattern. For example, blade torque sensor information may be used to identify where grass is thicker requiring a slowing of the mower, or motor torque may be used to determine that the ground is either soft or hard such that a change in turn type is warranted—e.g., K-turn for soft ground and U-turn for hard ground so that the mower does not harm the grass when turning. In such examples, such mower parameters may be associated with the map of the region and/or time of year such that the mower may mow (or plan patterns according to) such optimizations in the future.

The selection of a particular mow pattern may depend upon the mow patterns that were previously used for a particular region of the job site. For example, mow patterns may change from the previously used pattern with regard to striping direction to facilitate grass health. As a non-limiting example, striping is determined to optimize how perpendicular cuts are with respect to the last cut. Of course, striping directions may be based on a time of year (season), weather, etc. Specific mow patterns may also be selected to create a particular aesthetic striping look of the mown grass.

If the mow pattern is for a mower that operates within a fleet of mowers at a job site, the pattern development takes this fact into account and optimizes each mower's pattern under a fleet construct. As such, in one example, the mower's in the fleet may be arranged in a flying V or chevron position as the mowers cover the job site. In other examples, the mowers may mow separate portions of the job site in a patchwork pattern (e.g., having alternating stripes, confined regions for mowing, or the like).

Once the pattern is produced/updated, at 712, the method 700 stores the updated pattern for subsequent provisioning at 422 of FIG. 4. The pattern may be communicated to the mower(s) for immediate use or for use at a later time. Such communication may comprise, for example, being accessible or distributed from a central server (e.g., server 108) and/or shared via a peer-to-peer network such as when all mowers of a fleet are collocated in a region, such as when housed in the depot for charging and/or data transfer. The method 700 ends at 714.

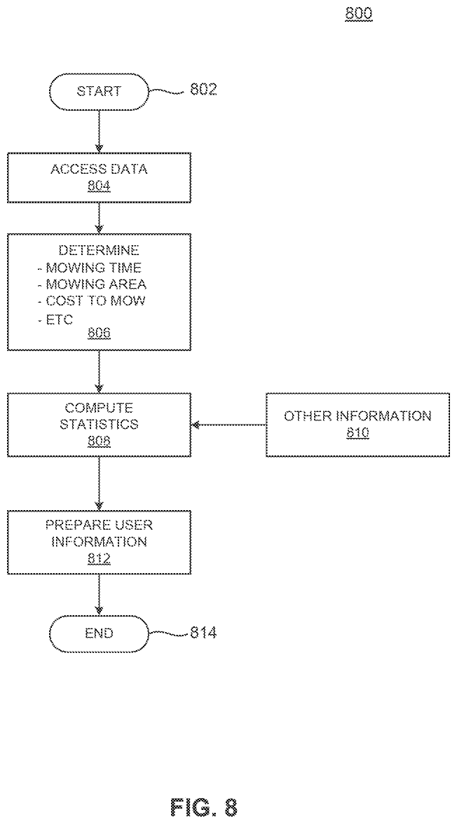

FIG. 8 depicts a flow diagram of a method 800 that is performed upon execution of the user information generation sub-program 412 of FIG. 4 in accordance with an example of the invention. The method 800 begins at 802 and proceeds to 804 where the sensor data is accessed (or otherwise received). At 806, using the sensor data, the method 800 determines metrics of a completed mowing task that are of interest to the landscape business and/or the customer. For example, the method 800 determines one or more of: the mowing time consumed to complete the mowing task; an amount of energy (e.g., a change in state of charge of the mower) to perform the mowing task; a size of the mowed area (e.g., in total acres); field operator time required to complete each task; number of obstacles encountered by the mower(s); travel time between job sites; an amount of area covered during a mowing task; a number of stripes required to cover the region; an average number of times a portion of the region was cut; an average area mowed per unit of time; an amount of time used by the lawn mower to mow the pattern; an amount of energy used by the lawn mower to mow the pattern; a total area mowed by the lawn mower and/or the total cost to mow the area (which may be determined on a rate per area basis). In addition, the method 800 may analyze video from the job site to determine which employees were present on the site and how long they worked.

At 808, the method 800 computes statistics based on the economic factors involved in the mowing task. For example, method 800 can compute the profit and loss for a given task, return on capital, mower life expectancy, and the like. The statistics from individual mowing tasks may be aggregated over time, across multiple job sites, and/or across the entire fleet. Thus, the method 800 may determine total costs in dollars and/or energy to perform a task or tasks for each customer.

At 810, other information from other sources may be necessary to compute the statistics, such information includes, for example, one or more of: as capital costs, employee salaries, irrigation system data, weather reports, and the like. The information supplied at 810 includes any information that is not available from the sensor data. The computed statistics may be for the specific mowing task, for the job site, for the fleet, and/or for the entire landscape business. Additionally, customer billing information may be generated from the statistics regarding the customer's job site.

At 812, the method 800 prepares user information for provisioning to users, e.g., landscape business management, customers, employees, and the like. Such user information may comprise customer invoices that may detail the site, it's area, the time required to mow, the staff involved in the mowing task and the like as may be generated based at least in part on the data collected. At 422 in FIG. 4, such invoices may be electronically transmitted to the customer, automatically paid, electronically paid, displayed on the customer device(s), etc. The invoices may be produced upon completion of a task or periodically (e.g., weekly, quarterly, etc.). Additional information may be made available to system users as described below with respect to FIG. 9.

The method 800 ends at 814.

FIG. 9 depicts a flow diagram of a method 900 that is performed upon execution of the user notification generation sub-program 414 of FIG. 4 in accordance with an example of the invention. The method 900 begins at 902 and proceeds to 904 where the sensor data is accessed (or otherwise received). At 906, the method 900 determines the environment requirements of the job site. In one example, the environment requirements can be produced by the analysis sub-program of FIG. 6 described above. These environment requirements include, for example, tree and bush trimming requirements, leaf raking requirements, general landscaping requirements, watering (irrigation levels), herbicide application, trash removal, and the like. The requirements may be derived from the sensor data using machine learning/computer vision techniques to determine locations and types of vegetation that exists at the job site. Changes in the vegetation over time may be tracked to determine when trimming is needed.

At 908, at least one user (e.g., customer, local site manager, business management, etc.) is notified of the requirements. Once notified of a requirement, the user may act upon the notification by, for example, programming a robotic trimmer with a task of performing the recommended trimming or contacting a tree trimming service to perform the task. Notifications may include internet links to service provider web pages or on-line stores to simplify a customer's action to have the recommended services provided or for the customer to purchase required supplies, e.g., herbicide, mulch, grass seed, etc.

In addition, after a first communication (at a first time), the method 900 may repeat to access or receive additional data (at a second time after the first time) and confirm, based at least in part on the additional data, whether the condition of the property communicated in the first communication has been taken care of.

At 910, an optional notification may be communicated to an outside service provider such as an irrigation system repair service, tree trimming service, aeration service, etc. In one example, this notification may be automatic if the customer has pre-approved automated repairs. The method 900 ends at 912.

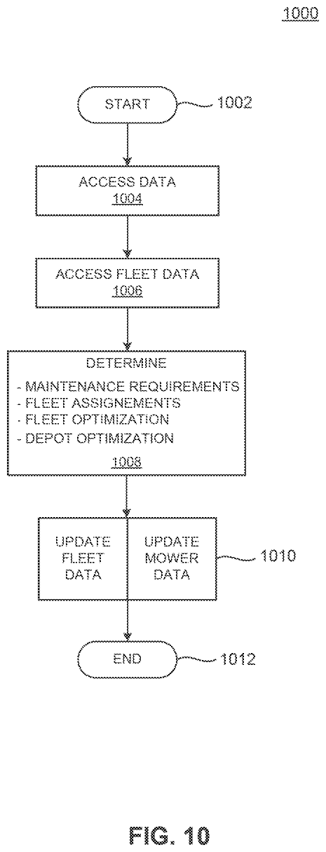

FIG. 10 depicts a flow diagram of a method 1000 that is performed upon execution of the fleet management sub-program 416 of FIG. 4 in accordance with an example of the invention. The method 1000 begins at 1002 and proceeds to 1004 where the sensor data is accessed (or otherwise received). At 1006, the method 1000 accesses the fleet data identifying the mower(s), their assigned tasks, mowing scheduling, maintenance scheduling, and the like. Such fleet information may be available from a fleet management database or spreadsheet. At 1008, the method 1000 determines, for example, mower maintenance requirements, mower task assignments, fleet optimization, depot optimization and the like. For example, through access to a maintenance schedule, the method 1000 may identify a mower is scheduled for maintenance and requires removal from task assignments. The method 1000 may schedule another mower to replace the mower that is to receive maintenance. Additionally, mowers with heavy use at a given job site may be rotated to sites with lighter requirements to extend the operational life of a given mower. Timing of when mowers are sent from the depot may be optimally scheduled based on travel distances to the site and mowing time required. Additionally, mowing schedules may be impacted by weather events and require the method 1000 to update scheduling in view of such events.

At 1010, the method 1000 updates the fleet data and the mower data, as necessary. The method 1000 in view of mower rescheduling, may also have to update one or more mower tasks, e.g., provide updated mow patterns and/or mow parameters. At 1012, the method 1000 ends.

### Example Clauses

A. A system comprising: one or more processors; and one or more non-transitory computer readable media having instructions stored thereon, which, when executed by the one or more processors, cause the one or more processors to perform operations comprising: receiving data from at least one autonomous lawn mower of a fleet of autonomous lawn mowers, the data comprising at least sensor data from one or more sensors associated with the at least one autonomous lawn mower, the sensor data captured while the at least one autonomous lawn mower traversed an environment in accordance with a mow pattern; based at least in part on the data, generating information indicative of one or more of: a diagnostic of the at least one autonomous lawn mower, an attribute associated with the environment, or a metric associated with the at least one autonomous lawn mower performing a task; and providing the information to a user.

B. The system as described in example clause A, wherein the diagnostic comprises one or more of: a state of charge of a battery of the autonomous lawn mower, a motor temperature of a motor of the autonomous lawn mower, a tire pressure of a wheel associated with the autonomous lawnmower, an attribute of blade maintenance, a total time mowed while mowing the pattern followed by the at least one autonomous lawn mower while traversing the environment, a distance travelled by the at least one autonomous lawn mower since a last maintenance service, a mow pattern tracking error, a number of instances of human intervention while completing the mow pattern, a battery health, software and computing diagnostic information for lawn mower software and hardware, or functionality of the one or more sensors.

C. The system as described in example clause A or B, wherein the attribute comprises one or more of: characteristics of a lawn mowed by the at least one autonomous lawn mower, position of obstacles in the environment, identity of obstacles in the environment, identity of vegetation in the environment, or position of vegetation in the environment.

D. The system as described in example clause A-C, wherein the metric comprises one or more of: an amount of area covered during a mowing task, a number of stripes required to cover the region, an average number of times a portion of the region was cut, an average area per time, an amount of time used by the autonomous lawnmower to mow the pattern, an amount of energy used by the autonomous lawnmower to mow the pattern, or a total area mowed by the autonomous lawnmower.

E. The system as described in example clause A-D, wherein the operations further comprise receiving additional data from an additional autonomous lawn mower of the fleet of autonomous lawn mowers.

F. The system as described in example clause A-E, wherein the information comprises an attribute of the environment, and wherein the attribute comprises one or more of: a tree to be cut, a bush to be trimmed, a portion of the region needing lawn maintenance, a region requiring a change in irrigation levels, or a location of trash to be removed.

G. The system as described in example clause A-F, wherein the information is communicated at a first time, and wherein the operations further comprise: receiving, at a second time after the first time, additional data from the at least one autonomous lawn mower; and confirming, based at least in part on the additional data, whether the condition of the property has been taken care of.

H. The system as described in example clause A-G, wherein the one or more sensors comprise one or more of a camera, a radar, a lidar, an ultrasonic transducer, or a Global Navigation Satellite System (GNSS) receiver, and wherein the operations further comprising: determining, based at least in part on the sensor data, location of one or more obstacles in the environment associated with the mow pattern; determining, based at least in part on the obstacles, an updated mow pattern for the at least one lawn mower; and transmitting, to the at least one autonomous lawn mower, the updated mow pattern.

I. The system as described in example clause A-H, wherein the operations further comprise: determining, as the updated mow pattern, a mow pattern that minimizes one or more of an amount of energy or an amount of time for the at least one autonomous lawn mower to complete mowing in accordance with the mow pattern.

J. The system as described in example clause A-I, wherein an attribute of the environment comprises: at least one environment requirement of a job site based on the sensor data and notifying a customer of the environment requirements including services to fulfill the at least one environment requirement.

K. A method comprising: receiving data from at least one autonomous lawn mower of a fleet of autonomous lawn mowers, the data comprising at least sensor data from one or more sensors associated with the at least one autonomous lawn mower, the sensor data captured while the at least one autonomous lawn mower traversed an environment in accordance with a mow pattern; based at least in part on the data, generating information indicative of one or more of: a diagnostic of the at least one autonomous lawn mower, an attribute associated with the environment, or a metric associated with the at least one autonomous lawn mower performing a task; and providing the information to a user.

L. The method as described in example clause K, wherein the diagnostic comprises one or more of a state of charge of a battery of the autonomous lawn mower, a motor temperature of a motor of the autonomous lawn mower, a tire pressure of a wheel associated with the autonomous lawnmower, an attribute of blade maintenance, a total time mowed while mowing the pattern followed by the at least one autonomous lawn mower while traversing the environment, a distance travelled by the at least one autonomous lawn mower since a last maintenance service, a mow pattern tracking error, a number of instances of human intervention while completing the mow pattern, a battery health, software and computing diagnostic information for lawn mower software and hardware, or functionality of the one or more sensors.

M. The method as described in example clause K or L, wherein the attribute comprises one or more of: characteristics of a lawn mowed by the at least one autonomous lawn mower, position of obstacles in the environment, identity of obstacles in the environment, identity of vegetation in the environment, or position of vegetation in the environment.

N. The method as described in example clause K-M, wherein the metric comprises one or more of: an amount of area covered during a mowing task, a number of stripes required to cover the region, an average number of times a portion of the region was cut, an average area per time, an amount of time used by the autonomous lawnmower to mow the pattern, an amount of energy used by the autonomous lawnmower to mow the pattern, or a total area mowed by the autonomous lawnmower.

O. The method as described in example clause K-N, further comprising: receiving additional data from an additional autonomous lawn mower of the fleet of autonomous lawn mowers.

P. The method as described in example clause K-O, wherein the information comprises an attribute of the environment, and wherein the attribute comprises one or more of: a tree to be cut, a bush to be trimmed, a portion of the region needing lawn maintenance, a region requiring a change in irrigation levels, or a location of trash to be removed.

Q. The method as described in example clause K-P, wherein the information is communicated at a first time, and wherein the operations further comprise: receiving, at a second time after the first time, additional data from the at least one autonomous lawn mower; and confirming, based at least in part on the additional data, whether the condition of the property has been taken care of.

R. The method as described in example clause K-Q, wherein the one or more sensors comprise one or more of a camera, a radar, a lidar, an ultrasonic transducer, or a Global Navigation Satellite System (GNSS) receiver, and wherein the method further comprises: determining, based at least in part on the sensor data, location of one or more obstacles in the environment associated with the mow pattern; determining, based at least in part on the obstacles, an updated mow pattern for the at least one lawn mower; and transmitting, to the at least one autonomous lawn mower, the updated mow pattern.

S. The method as described in example clause K-R, further comprises: determining, as the updated mow pattern, a mow pattern that minimizes one or more of an amount of energy or an amount of time for the at least one autonomous lawn mower to complete mowing in accordance with the mow pattern.

T. The method as described in example clause K-S, wherein an attribute of the environment comprises at least one environment requirement of a job site based on the sensor data and the method comprising: notifying a customer of the environment requirements including services to fulfill the at least one environment requirement.

U. One or more non-transitory computer readable media comprising instructions which, when executed by one or more processors, cause the one or more processors to perform the method as described in any one or more of example clauses K-S.

### CONCLUSION

Here multiple examples have been given to illustrate various features and are not intended to be so limiting. Any one or more of the features may not be limited to the particular examples presented herein, regardless of any order, combination, or connections described. In fact, it should be understood that any combination of the features and/or elements described by way of example above are contemplated, including any variation or modification which is not enumerated, but capable of achieving the same. Unless otherwise stated, any one or more of the features may be combined in any order.

As above, figures are presented herein for illustrative purposes and are not meant to impose any structural limitations, unless otherwise specified. Various modifications to any of the structures shown in the figures are contemplated to be within the scope of the invention presented herein. The invention is not intended to be limited to any scope of claim language.

Where “coupling” or “connection” is used, unless otherwise specified, no limitation is implied that the coupling or connection be restricted to a physical coupling or connection and, instead, should be read to include communicative couplings, including wireless transmissions and protocols.

Any block, step, module, or otherwise described herein may represent one or more instructions which can be stored on a non-transitory computer readable media as software and/or performed by hardware. Any such block, module, step, or otherwise can be performed by various software and/or hardware combinations in a manner which may be automated, including the use of specialized hardware designed to achieve such a purpose. As above, any number of blocks, steps, or modules may be performed in any order or not at all, including substantially simultaneously, i.e. within tolerances of the systems executing the block, step, or module.

Where conditional language is used, including, but not limited to, “can,” “could,” “may” or “might,” it should be understood that the associated features or elements are not required. As such, where conditional language is used, the elements and/or features should be understood as being optionally present in at least some examples, and not necessarily conditioned upon anything, unless otherwise specified.

Where lists are enumerated in the alternative or conjunctive (e.g. one or more of A, B, and/or C), unless stated otherwise, it is understood to include one or more of each element, including any one or more combinations of any number of the enumerated elements (e.g. A, AB, AB, ABC, ABB, etc.). When “and/or” is used, it should be understood that the elements may be joined in the alternative or conjunctive.

1. A system comprising:
one or more processors; and
one or more non-transitory computer readable media having instructions stored thereon, which, when executed by the one or more processors, cause the one or more processors to perform operations comprising:
receiving data from at least one autonomous lawn mower of a fleet of autonomous lawn mowers, the data comprising at least sensor data from one or more sensors associated with the at least one autonomous lawn mower, the sensor data captured while the at least one autonomous lawn mower traversed an environment in accordance with a mow pattern;
based at least in part on the data, generating information indicative of one or more of:
a diagnostic of the at least one autonomous lawn mower,
an attribute associated with the environment, or
a metric associated with the at least one autonomous lawn mower performing a task; and
providing the information to a user.

2. The system of claim 1, wherein the diagnostic comprises one or more of:
a state of charge of a battery of the autonomous lawn mower,
a motor temperature of a motor of the autonomous lawn mower,
a tire pressure of a wheel associated with the autonomous lawnmower,
an attribute of blade maintenance,
a total time mowed while mowing the pattern followed by the at least one autonomous lawn mower while traversing the environment,
a distance travelled by the at least one autonomous lawn mower since a last maintenance service,
a mow pattern tracking error,
a number of instances of human intervention while completing the mow pattern,
a battery health,
software and computing diagnostic information for lawn mower software and hardware, or
functionality of the one or more sensors.

3. The system of claim 1, wherein the attribute comprises one or more of:
characteristics of a lawn mowed by the at least one autonomous lawn mower,
position of obstacles in the environment,
identity of obstacles in the environment,
identity of vegetation in the environment, or
position of vegetation in the environment.

4. The system of claim 1, wherein the metric comprises one or more of:
an amount of area covered during a mowing task,
a number of stripes required to cover the region,
an average number of times a portion of the region was cut,
an average area per time,
an amount of time used by the autonomous lawnmower to mow the pattern,
an amount of energy used by the autonomous lawnmower to mow the pattern, or
a total area mowed by the autonomous lawnmower.

5. The system of claim 1, wherein the operations further comprise receiving additional data from an additional autonomous lawn mower of the fleet of autonomous lawn mowers.

6. The system of claim 1, wherein the information comprises an attribute of the environment, and wherein the attribute comprises one or more of:
a tree to be cut,
a bush to be trimmed,
a portion of the region needing lawn maintenance,
a region requiring a change in irrigation levels, or
a location of trash to be removed.

7. The system of claim 6, wherein the information is communicated at a first time, and wherein the operations further comprise:
receiving, at a second time after the first time, additional data from the at least one autonomous lawn mower; and
confirming, based at least in part on the additional data, whether the condition of the property has been taken care of.

8. The system of claim 1, wherein the one or more sensors comprise one or more of a camera, a radar, a lidar, an ultrasonic transducer, or a Global Navigation Satellite System (GNSS) receiver, and
wherein the operations further comprising:
determining, based at least in part on the sensor data, location of one or more obstacles in the environment associated with the mow pattern;
determining, based at least in part on the obstacles, an updated mow pattern for the at least one lawn mower; and
transmitting, to the at least one autonomous lawn mower, the updated mow pattern.

9. The system of claim 8, wherein the operations further comprise:
determining, as the updated mow pattern, a mow pattern that minimizes one or more of an amount of energy or an amount of time for the at least one autonomous lawn mower to complete mowing in accordance with the mow pattern.

10. The system of claim 1, wherein an attribute of the environment comprises:
at least one environment requirement of a job site based on the sensor data and notifying a customer of the environment requirements including services to fulfill the at least one environment requirement.

11. A method comprising:
receiving data from at least one autonomous lawn mower of a fleet of autonomous lawn mowers, the data comprising at least sensor data from one or more sensors associated with the at least one autonomous lawn mower, the sensor data captured while the at least one autonomous lawn mower traversed an environment in accordance with a mow pattern;
based at least in part on the data, generating information indicative of one or more of:
a diagnostic of the at least one autonomous lawn mower,
an attribute associated with the environment, or
a metric associated with the at least one autonomous lawn mower performing a task; and
providing the information to a user.

12. The method of claim 11, wherein the diagnostic comprises one or more of:
a state of charge of a battery of the autonomous lawn mower,
a motor temperature of a motor of the autonomous lawn mower,
a tire pressure of a wheel associated with the autonomous lawnmower,
an attribute of blade maintenance,
a total time mowed while mowing the pattern followed by the at least one autonomous lawn mower while traversing the environment,
a distance travelled by the at least one autonomous lawn mower since a last maintenance service,
a mow pattern tracking error,
a number of instances of human intervention while completing the mow pattern,
a battery health,
software and computing diagnostic information for lawn mower software and hardware, or
functionality of the one or more sensors.

13. The method of claim 11, wherein the attribute comprises one or more of:
characteristics of a lawn mowed by the at least one autonomous lawn mower,
position of obstacles in the environment,
identity of obstacles in the environment,
identity of vegetation in the environment, or
position of vegetation in the environment.

14. The method of claim 11, wherein the metric comprises one or more of:
an amount of area covered during a mowing task,
a number of stripes required to cover the region,
an average number of times a portion of the region was cut,
an average area per time,
an amount of time used by the autonomous lawnmower to mow the pattern,
an amount of energy used by the autonomous lawnmower to mow the pattern, or
a total area mowed by the autonomous lawnmower.

15. The method of claim 11, further comprising:
receiving additional data from an additional autonomous lawn mower of the fleet of autonomous lawn mowers.

16. The method of claim 11, wherein the information comprises an attribute of the environment, and wherein the attribute comprises one or more of:
a tree to be cut,
a bush to be trimmed,
a portion of the region needing lawn maintenance,
a region requiring a change in irrigation levels, or
a location of trash to be removed.

17. The method of claim 16, wherein the information is communicated at a first time, and wherein the operations further comprise:
receiving, at a second time after the first time, additional data from the at least one autonomous lawn mower; and
confirming, based at least in part on the additional data, whether the condition of the property has been taken care of.

18. The method of claim 17, wherein the one or more sensors comprise one or more of a camera, a radar, a lidar, an ultrasonic transducer, or a Global Navigation Satellite System (GNSS) receiver, and
wherein the method further comprises:
determining, based at least in part on the sensor data, location of one or more obstacles in the environment associated with the mow pattern;
determining, based at least in part on the obstacles, an updated mow pattern for the at least one lawn mower; and
transmitting, to the at least one autonomous lawn mower, the updated mow pattern.

19. The method of claim 18, further comprises:
determining, as the updated mow pattern, a mow pattern that minimizes one or more of an amount of energy or an amount of time for the at least one autonomous lawn mower to complete mowing in accordance with the mow pattern.

20. The method of claim 19, wherein an attribute of the environment comprises at least one environment requirement of a job site based on the sensor data and the method comprising:
notifying a customer of the environment requirements including services to fulfill the at least one environment requirement.
